(19) United States
(12) Patent Application Publication
(10) Pub. No.: US 2015/0075407 A1
(43) Pub. Date: Mar. 19, 2015

(54) SUPER-HYDROPHOBIC COMPOSITION, PREPARATION OF SAME AND SUPER-HYDROPHOBIC PAPER

(71) Applicant: COPAMEX, S.A. DE C.V., San Pedro Garza Garcia, NL (MX)

(72) Inventors: José Trinidad Peregnina Gómez, Guadalupe (MX); Eduardo Duarte Villa, San Nicolas de los Garza (MX); Miguel De Dios Hernández, Apodaca (MX); Gonzalo Castro Contreras, General Escobedo (MX)

(21) Appl. No.: 14/387,217

(22) PCT Filed: Mar. 22, 2013
(86) PCT No.: PCT/MX2013/000038

§ 371 Date: Sep. 22, 2014

(30) Foreign Application Priority Data
Mar. 23, 2012 (MX) MX/A/2012/003548

(51) Int. Cl. D21H 19/10; C09K 3/18

(52) U.S. Cl. CPC D21H 19/10; C09K 3/18
USPC 106/244; 106/287.18; 106/243

(57) ABSTRACT

A super-hydrophobic composition for layer recovering, particularly paper, in which the composition is a mixture of at least one hydrophobic agent of chromium complex and inorganic nanoparticles selected from a group consisting of hydrophobic nanoparticles, hydrophilic nanoparticles and combinations thereof, with an average particle size of 1 nm to 35 nm.

### TECHNICAL FIELD OF THE INVENTION

The present invention relates to coating compositions. More particularly, the invention relates to a super-hydrophobic composition for coating substrates, particularly paper.

### BACKGROUND OF THE INVENTION

The phenomena of super-hydrophobicity and ultra-hydrophobic surfaces present themselves on surfaces that have a contact angle of water of approx. 115° to approx. 150° or above 150°. In nature, lotus leaves are considered super-hydrophobic, since water droplets can travel freely their surface, collecting surface dirt on their path. This behavior is believed to be a result of nanotexture of their surface, and a layer of wax present in the leaf. However, super-hydrophobic surfaces cannot be obtained by simply coating a surface with a hydrophobic or oleophobic coating, but it is also required to have a nanotexture, that is, small protrusions on the surface that result in a topography of the order from 1 nm to 1000 nm. When a nanotexture is added to a surface, the latter becomes hydrophobic so that angle contact with water increases from 100° to 120° to over 150°. Without being limited by theory, it is believed that this nanotexture produces this hydrophobic effect, when trapping air into the spaces between the structural features of the surface. Water droplets interact both with the very small tips of hydrophic particles and with the larger valleys between the particles, where the air is maintained. Air is also highly hydrophobic. The water comes into contact with the tips of the particles and does not penetrate the air bags located in the valleys. As a result, the water cannot remain fixed on the surface and moves anywhere on it according to its inclination.

An example of super-hydrophobic composition of the prior art is described by R. Laurie Lawin, et al, in U.S. Patent Publication US-2008/0268233A1. Laurie demonstrates a super-hydrophobic or ultra-hydrophobic coating composition comprising a hydrophobic polymer that may be a homopolymer or compolimer of polyalkylene, polyacrylate, polymethylacrylate, polyester, polyamide, polyurethane, polyvinylarilene, polyvinyl ester, copolymer of polyvinylarilene/alkylene, polyalkylene oxide or combinations thereof with particles having an average size of 1 nm to 25 microns.

### SUMMARY OF THE INVENTION

In view of the above and with the purpose of solving the limitations encountered, it is the object of the invention to provide a superhydrophobic composition for coating of a substrate formed by at least one hydrophobic agent of chromium complex and inorganic nanoparticles.

Another object of the present invention to provide a process for the preparation of a super-hydrophobic composition for coating with the resulting mixture, which comprises mixing at least one hydrophobic agent of chromium complex and inorganic nanoparticles.

Another object of the present invention is to provide the use of a super-hydrophobic composition which comprises at least one hydrophobic agent of chromium complex and inorganic nanoparticles for the production of a super-hydrophobic paper.

### DETAILED DESCRIPTION OF THE INVENTION

The characteristic details of the invention are described in the following paragraphs, which are for the purpose of defining the invention but without limiting its scope.

The coating composition of the invention is applicable to a wide variety of substrates including but not limited to plastics (polyethylene, polypropylene, nylon, silicone rubber, PVC, polystyrene, polyurethane, etc.), glass, natural polymers, such as wood (cellulose), polysaccharides, proteins, paper, ceramics, metals and composites.

The coating composition according to the invention shows components which in turn could consist of multiple components. The components are individually described below, without necessarily being described in an order of importance.

The property of being “hydrophilic” refers to a constitutional property of a molecule or functional group to penetrate the aqueous phase or to remain there. Therefore, the “hydrophobic” property refers to the constitutional property of a molecule or functional group to behave exophilically with regard to water, i.e., to tend not to penetrate water, or to leave the aqueous phase. For further details, see Rompp Lexikon Lacke and Druckfarben, Georg Thieme Verlag, Stuttgart, Nueva York, 1998, “hydrophilicity”, “hydrophobocity”, pages 294 and 295.

### Hydrophobic Agent of Chromium Complex

The present invention includes at least one hydrophobic agent of chromium complex, which is representable (omitting associated solvent molecules such as water molecules and/or alcohol) through the formula:

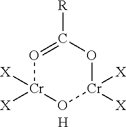

wherein R is a hydrocarbon chain of at least 7 and more preferably of at least 12 carbon atoms and X is halogen other than fluorine.

In an aqueous or alcoholic solution, molecules and the solvent may be coordinated, for example:

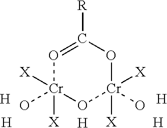

wherein R′ is water or alcohol. A subsequent hydrolysis/neutralization frees X anions and coordinates with further solvents; solvents groups can then lose protons and react with adjacent entities that support —OH, by coordination followed by elimination of water, providing links —O— to complex adjacents or substrates and to the hydrophibic nanoparticles that are more described hereafter.

Preferred reaction conditions use the hydrophobic agent of chromium complex in a solution, e.g., alcoholic, aqueous or aqueous/alcoholic, adjusted to give a degree of preliminary association or polymerisation of hydrophobic agent of chromium complex in solution, but without precipitation.

Hydrophobic agents of chromium complex suitable for the invention are commercially available, for example, complex fatty acid/hydroxy/chromium chloride (III), distributed by Dupont under the tradename Quilon® or the vegetable based alternative of stearyl acid released by Northern Products Inc. under the tradename NECCOPLEX®.

These chromium complexes, provided in isopropanol solutions, which can be diluted in water will correspond to the formula:

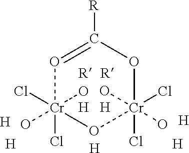

wherein R is alkyl C14 to C18 and R′OH is isopropanol. The materials treated with these are approved for use in contact with food and drugs.

Generally, the composition of the present invention is developed by contacting the hydrophobic nanoparticles with the hydrophobic agent solution of chromium complex, optionally followed by wet heating. The hydrophobic nanoparticles can be treated in great amounts. In some cases care should be taken (for example, use of agitation, fluidisation, etc.) in preventing hydrophobic nanoparticles from sticking or agglomerate with each other.

Quilon® is available in five grades. Each degree containing different amounts of chromium, chlorine and fatty acid. Fatty acids are also used in different length strings. The Quilon® C is pentahydroxy(tetradecanoate)dichromic.

Grades H and M are both tetradecanoate chromic chloride hydroxide (1:2:4:1), but vary in the concentrations of active ingredients (higher in grade H).

Grades S and L are octadecanoate chromic chloride hydroxide (1:2:4:1) and again they differ in strength, being higher in the degree of L.

The contents of chromium, chlorine and fatty acid of the five grades (including isopropanol solvent) are shown in table 1 below (taken from product information supplied by Du Pont®).

TABLE 1

| | Degree | | | | |
|---|---|---|---|---|---|
| | C | H | L | M | S |
| | Content in wt % | | | | |
| Chromium | 5.7 | 9.2 | 9.2 | 5.7 | 5.7 |
| Chloride | 7.8 | 12.6 | 12.7 | 7.8 | 7.8 |
| Fatty acid | 11.8 | 19.0 | 21.2 | 11.7 | 14.8 |

The reactivity of the hydrophobic agent of chromium complex part is determined by the degree of hydrolysis and polymerisation. The Quilon® degrees H, L, M and S are monomers and react rapidly with negatively charged materials. The chromium complex in the Quilon® grade C is more polymerised and binds to the surfaces of the substrate and the hydrophobic nanoparticles at lower cure temperatures; the complex also binds more rapidly from organic dissolvents.

The hydrophobic agent of chromium complex is used in an amount between approx. 0.01% to approx. 50% by weight, based on the weight of the composition. In one embodiment, the hydrophobic agent of chromium complex is used in an amount ranging from about 3% to about 30% by weight.

### Hydrophobic or Hydrophilic Inorganic Nanoparticles

Super-hydrophobic composition of the present invention employs hydrophobic, hydrophilic inorganic nanoparticles or combinations thereof. Preferably hydrophobic nanoparticles are used for their affinity with the hydrophobic agent of chromium complex, however, the use of hydrophilic nanoparticles in combination with the hydrophobic agent of chromium complex and other compounds gives rise to said hydrophilic nanoparticles to acquire the hydrophobic ability.

Inorganic nanoparticles used in the composition of the present invention have an average particle size of about 1 nm to about 35 nm, and preferably from about 5 nm to about 20 nm.

The inorganic nanoparticles are used in an amount between approx. 0.01% to approx. 50% by weight, based on the weight of the composition. In one embodiment, the inorganic particles are used in an amount between approx. 5% to approx. 35% by weight.

Hydrophobic nanoparticles are preferably prepared by modifying the surface of pyrogenic silica with compounds containing hydrophobic groups.

Suitable hydrophobic nanoparticles preferably include inorganic nanoparticles that can carry on its surface hydrophobic groups. Examples of suitable hydrophobic nanoparticles are produced by the reaction of inorganic hydrophilic nanoparticles with compounds having hydrophobic groups, particularly with organofunctional silicon compounds having at least one functional group which reacts with the hydrophilic groups of the hydrophilic inorganic nanoparticles which are at least one hydrophobic radical.

Examples of hydrophilic inorganic nanoparticles used for the manufacture of hydrophobic nanoparticles are those based on oxides and/or mixed oxides, including oxide hydrate of at least one metal or semi-metal from the main groups two and six, and transition groups one to eight of the Periodic Table of the Chemical Elements or of the lanthanides, particularly oxides and/or mixed oxides, including oxide hydrates, selected from the group of elements Si, Al, Ti, Zr, and/or Ce Examples are nanoparticles based on SiO₂, for example, pyrogenically prepared silica, silicates, Al₂O₃, aluminum hydroxide, aluminosilicates, TiO₂, Titanates, ZrO₂, or sirconates, CeO₂, especially pyrogenic silica-based nanoparticles.

As compounds having hydrophobic groups, it is particularly preferred to use organ functional silicon compounds that have at least one alkyl group having 1 to 50 carbon atoms, in particular having from 1 to 10 carbon atoms and having at least one hydrolyzable group and/or at least one OH group and/or an NH group. Examples of compounds having hydrophobic groups are alkylalcoxisilanes, especially dialkyldialcoxisilanes and alkyltrioalcoxisilanes, preferably trialkylclorosilanes and dialkyldiclorosilanes, alkylpolysiloxanes, dialkylpolysiloxanes and alkyldisilozanes and the like. As compounds having hydrophobic groups are also suitable: various monomeric and/or oligomeric silicic esters having methoxy, ethoxy or n-proposi and/or isopropoxy and having a degree of oligomerization of 1 to 50, in particular from 2 to 10, preferably 3 to 5.

Additional examples of organic functional compounds are the compounds of organic functional silica disclosed in German Patent DE-10049628 which is incorporated in full by reference.

Additional examples of compounds having hydrophobic groups are products known and commercially available under the trade name DYNASILAN® and sold by Hüls.

As compounds having hydrophobic groups are particularly preferred to use dimethyldichlorosilane and/or hexamethyldisilazane and/or octyltrimethoxysilane and/or dimethylpolysiloxane.

Particularly preferred hydrophobic nanoparticles are nanoparticles based on the reaction products of SiO2 and dimethyldichlorosilane and hexamethyldisilazane, in particular reaction products of SiO2 and dimethyldichlorosilane.

Examples of hydrophobic nanoparticles that can be used are standard products sold by Degussa under the trade name Aerosil®, especially Aerosil® 8200, R106, R202, R972, R972V, R974, R974V, R805 or R812, or by Wacker, under the trademark or HDK type designation, especially HDK H15, H 18, H20, H30 or 2000.

In the case of silicas which may be used, see, for instance, the brochure “Pyrogen Kiesselsauren—Areosil®” from Silvento, Degussa-Hüls AG.

Other examples of commercially available hydrophobic nanoparticles are CMP HB215, HB220, HB615, HB620, HB630, HB720.

Examples of inorganic hydrophilic nanoparticles used for the manufacture of super-hydrophobic nanoparticles of this invention, are those based on oxides and/or mixed oxides, including oxide hydrate of at least one metal or semi-metal from the main groups two and six, and transition groups one to eight of the Periodic Table of the Chemical Elements or of the lanthanides, particularly oxides and/or mixed oxides, including oxide hydrates, selected from the group of elements Si, Al, Ti, Zr, and/or Ce. Examples are nanoparticles based on SiO₂, for example, pyrogenically prepared silica, silicates, Al₂O₃, aluminum hydroxide, aluminosilicates, TiO₂, Titanates, ZrO₂, or sirconates, CeO₂, especially pyrogenic silica-based nanoparticles.

Inorganic nanoparticles can be selected from nanoparticles of alumina, silica nanoparticles, nanoparticles of titanium oxide, zirconium oxide nanoparticles, gold nanoparticles, silver nanoparticles, nickel nanoparticles, nickel oxide nanoparticles, iron oxide nanoparticles, nanoparticles of alloys, and combinations thereof.

### Metal Salt Lubricant

The composition of the present invention further includes at least one metal salt lubricant which acts as a release agent.

To obtain the metal salt lubricant, organic carboxylic acids are used, preferably organic monocarboxylic acids with 8 to 24 carbon atoms, preferably 16 to 20 carbon atoms, for example, lauric acid, palmitic acid, oleic acid, isostearyl acid and preferably stearyl acid. It has shown a very good efficacy and therefore stearyl acid is preferably used in the trade, and it may contain up to 10% by weight, preferably up to 5% by weight of other carboxylic acids, if appropriate, unsaturated, with more than 8 carbon atoms.

As metals for forming the metal salt lubricant, metals of groups IA, IB, IIA or IIB are used of the Periodic Table of the Chemical Elements, as well as aluminum, chromium, molybdenum, iron, cobalt, nickel, zinc, lead, antimony or bismuth. Alkali metals are preferably used, especially sodium and potassium, alkaline-earth metals, especially magnesium and calcium.

Preferably used as metal salts are those of isostearyl acid and/or especially of stearyl acid being preferred calcium stearate, sodium stearate, potassium stearate, ammonium stearate, zinc stearate, zinc isostearate, or a mixture of at least two stearates of those mentioned.

The metal salt lubricant is used in an amount between approx. 0.01% to approx. 10% by weight, based on the weight of the composition. In one embodiment, the metal salt lubricant is used in an amount between approx. 1% to approx. 5% by weight.

### Lecithin

The composition of the present invention further includes at least one lecithin. Pure lecithin is a phosphatidylcholine substituted with a fatty acid having the general structural formula:

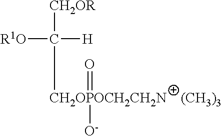

In practice, however, lecithin is seldom available in a pure form and, generally speaking, the term lecithin refers to a complex mixture, present in nature, of phosphatides, triglycerides, carbohydrates, sterols and other secondary ingredients.

Lecithin is usually obtained from a vegetable oil, soybean oil being the main source. Other sources of lecithin include egg yolk, milk and brains of animals. Phosphatides present in lecithin are similar, except that their proportions vary. Similarly, the other secondary constituents of lecithin vary depending on the particular source.

The typical fatty acid profiles of a commercially available lecithin are shown in the following Table 2:

TABLE 2

| | | | Commercial |
|---|---|---|---|
| Number of carbons | | Commercial | lecithin |
| and double bonds | Soy lecithin | lecithin | without oil |
| Saturated | | | |
| C16:0 | 9 | 15 | 19 |
| C16:0 | 5 | 5 | 5 |
| Total | 14 | 29 | 24 |
| Unsaturated | | | |
| C16:0 | 26 | 17 | 10 |
| C16:0 | 53 | 55 | 59 |
| C16:0 | 8 | 7 | 8 |
| Total | 86 | 80 | 76 |

A typical composition of soy lecithin, which is the most common commercial product is shown in the following Table 3:

TABLE 3

| Compound | Weight % |
|---|---|
| Phosphatidyl - choline (I) | 20 |
| Phosphatidyl - ethanolamine (II) | 15 |
| Phosphatidyl - inositol (III) | 20 |
| Phosphate acids and other | 5 |
| phosphates | |
| Carbon hydrates, sterols | 5 |
| Triglycerides | 35 |

Being I, II and III as follows:

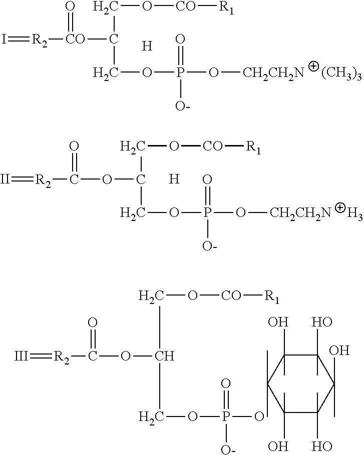

Can be used in the present invention any of these forms of naturally present lecithin. In addition, lecithin need not be pure and can be used as a stabilizer and viscosity reductor either commercially available grades of lecithin, which generally are mixtures of phosphatidyl—choline, phosphatidyl—ethanolamine, phosphatidyl—inositol (phosphatides), and triglycerides, regardless of the source, for example egg yolk, soy beans, etc. However, it is generally preferred to use a form of lecithin bleached twice to minimize any odors that may occur due to the use of natural products.

Some commercial sample of soy lecithin, are ALCOLEC® S which is a liquid soy lecithin, ALCOLEC® F 100 is a powdered soy lecithin and ALCOLEC® Z3 is a hydroxylated lecithin, all are available from American Lecithin Company.

Lecithin is used in any quantity. Typically, lecithin is used in an amount between approx. 0.01% to approx. 10% by weight, based on the weight of the composition. In one embodiment, lecithin is used in an amount between approx. 0.3% to approx. 2% by weight.

### Other Compounds

The composition of the present invention also includes water to facilitate the application as well as serve as the aqueous phase for the dispersion of the other compounds. It can also include at least one other alcohol-based dispersant, such as ethyl alcohol, isopropyl alcohol, n-propyl alcohol, n-butyl alcohol, stearyl alcohol, and butanol or sorbitol. On the other hand it may contain latex or urea, chitosan and PVA.

Also, it may further comprise starch, cationic starch, cationic amylopectin starch, acetylated starch, ethylated starch useful for application in pulp substrate in the stage size press as described hereunder.

### Process of Preparing a Super-Hydrophobic Paper

In one embodiment of the present invention, the super-hydrophobic composition is prepared by an aqueous base solution of at least one of the following compounds alcohol, lecithin, urea, latex and water in a ratio of 0.01% to 40% by weight, preferably from 3% to 30% by weight. Later, the inorganic nanoparticles, whether hydrophobic, hydrophilic or combinations thereof are added with a ratio of 0.01% to 50% by weight, preferably 5% to 35% by weight, slowly with constant stirring, during this time, the hydrophobic agent of chromium complex conditions the relation in a ratio of 0.01% to 50% by weight together with another dispersant, such as ethyl alcohol, isopropyl alcohol under constant agitation for a suitable period. So the resulting mixture comprises the mixture of the hydrophobic agent of chromium complex and the inorganic particles.

### Process of Preparing a Super-Hydrophobic Paper

The term “paper” or “cellulose substrate”, as used herein, includes not only paper and the production thereof, but also other products such as board and cardboard and their production.

In one embodiment of the invention, a cellulose substrate is coated on both sides by a super-hydrophobic composition of the invention in a size press in a continuous process of papermaking.

The cellulose substrate is formed from a pulp composition which possesses a blend of cellulosic fibers commonly referred to as wood pulp fibers obtained from raw material containing short fiber cellulose, long fiber cellulose or combinations thereof. The terms “short fiber cellulose” and “long fiber cellulose” refer to species of trees from which wood is obtained that serves as raw material for paper; thus, the short fiber cellulose is obtained mainly from trees of gymnosperm or conifer species such as pine or fir, while the long fiber pulp is obtained from trees of the angiosperm or flowering trees such as oak, birch or maple. The length of the fibers of short fiber cellulose ranges between 0.2 mm to 0.8 mm and the fiber of the long fiber cellulose ranges between 0.8 mm to 4.5 mm.

The cellulose substrate of the present invention may also include a mixture of recovered post-consumer paper and recovered white paper. The term “recovered post-consumer paper” in the context of the present disclosure relates to the role of paper or objects that have been used by the consumer and they have been returned to the factory for recycling. Examples of post-consumer paper recovered that can be used in the invention are: cardboard, solid cardboard, corrugated cardboard (OCC), simple corrugated cardboard, single-sided corrugated cardboard, double-sided corrugated cardboard, paperboard winding (Water Cardboard), duplex, triplex or multiplex cardboard, chipboard, solid cardboard, paper board, kraft paper, a mixture of soft paper (SMP), a mixture of hard paper (HMP), cuts of cardboard, factory wrappings, mechanical paper, newsprint, newsprint ink Quality (#7 ONP), special newsprint quality ink (#8 ONP), newsprint surplus (OI or OIN), magazine paper (OMG), new kraft paper cuts double corrugated (DLK), used brown kraft paper, mixed kraft cuttings, kraft colored new, supermarket waste bags (KGB), waste bags multilayer kraft paper, envelopes cuts new brown kraft paper, mixed paper shavings mechanical or semi-mechanical, mechanical paper for computer printout (GWCPO), paper cuts new for colored wrapping, paper cuts semi-bleached, unclassified office paper (UOP), sorted office paper (SOP), colored and copying ledger paper (MCL), sections of coated mechanical paper (CGS), cuts of bleached and printed paperboard, bleached paperboard and with printing errors, unprinted bleached board, and combinations thereof.

The term “recovered post-consumer paper” in the context of the present disclosure relates to white paper that was obtained from general waste paper used in the manufacture of said paper, or paper or paper objects that have been used by the end-consumer and that have been returned to the factory for recycling. Some examples of recovered white paper that can be used in this cellulosic coating invention are: white paper for papers—White Blank News (WBN), paper for publications—Publication Blanks (CPB), Soft White Shavings (SWS), Hard White Shavings (HWS), Hard White Envelop Cuttings (HWEC), white classified paper for ledger (CMS), white paper for general ledger (LMM), paper for Computer Printout (CPO), Coated Book Stock (CBS), and combinations thereof.

The cellulose substrate of the present invention may further contain sizing agents, such as alkyl ketene dimer and derivatives, alkenyl succinic anhydride, calcium stearate, magnesium stearate, cellulose and combinations thereof. In accordance with the stages of a paper making process of the prior art, an internal sizing of paper of the invention can be performed during or after the step of refining the pulp by applying alkyl ketene dimer and derivatives and alkenyl succinic anhydride, and a surface sizing step can be performed during a press-bonding stage by the application of alkyl ketene dimer and derivatives, alkenyl succinic anhydride, calcium stearate, cellulose stearate, and combinations thereof. For an efficient sizing it is desirable that the sizing agent is distributed uniformly through the fibers of the pulp, therefore it is preferred to prepare emulsions or dispersions containing an aqueous phase and finely divided particles dispersed in sizing agents thereof, and the use of emulsion stabilizers. The emulsion stabilizers or binding agents commonly used to prepare these emulsions are, for example, starches and cationic polymer are described below.

The cellulose substrate of the present invention, moreover, may further contain one or more fillers to increase the heat resistance of the paper of the present invention and serving as sealant for said paper, so that microparticles of loads of calcium carbonate may be incorporated, of granulated calcium carbonate, of precipitated calcium carbonate, kaolin, titanium dioxide, rutile titanium dioxide, anatasic titanium dioxide, hydrated aluminum silicate, talc and combinations thereof. In a papermaking process in accordance with the prior art, fillers can be added in the preparation and refining of paper pulp, and once paper is formed during the stage of gluing by pressing.

The cellulose substrate of the present invention may further contain one or more binding agents, for the purpose of increasing the strength of the paper of the invention and serve as a sealant against the passage of liquids, such as starch, cationic starch, cationic amylopectin starch, acetylated starch, ethylated starch, polyvinyl alcohol, carboxymethyl cellulose, anionic polyacrylamide, cationic polyacrylamide, epichlorohydrin polyamine, polyvinyl acetate, polyacrylates, polyacrylic acid, polystyrene, chloride of 2-hydroxy-3-(trimethylammonio) propyl amylopectin and combinations thereof. The cationic amylopectin starch may be added at any point in the process for making paper, for example, during or after the step of refining the paper pulp. If desired, besides the cationic amylopectin starch cationic starch may also be added to the pulp.

In one embodiment, the coating layers formed by super-hydrophobic composition of the present invention and applied by the size press cover both surfaces of the cellulose substrate. The coating layer penetrates minimally into the cellulose substrate, or does not penetrate it at all. Therefore, the super-hydrophobic composition may be substantially absent in the cellulose substrate. Control of penetration is achieved ideally with a coating in the size press with metering unit, so that the outer film thickness can be monitored closely. The paper porosity levels also affect the penetration of the coating. Controlling the thickness and penetration is key to create three separate adjacent layers forming the structure which has high strength external coatings around a core of minor density.

In one embodiment of a process used to make a cellulose substrate or super-hydrophobic paper of the present invention. Various types of papermaking machinery are known, many with variants of a typical type of machine from a wet end to a dry end. Thus, the present invention is not limited to a specific type of paper machine.

The wet end can comprise a refiner for mechanical treatment of the pulp, a tub of the machine, a headbox which discharges a wide jet of the composition of manufacture on a fabric section to form a fibrous paper web, a section of fabric having an extremely thin mobile sieve mesh, a press section and a drying section comprising a plurality of support rollers which dry the fibrous web and transport it to the size press.

A super-hydrophobic composition is mixed for coating according to the invention in a mixing tank. The super-hydrophobic mixed composition is transported to a size press tank and then pressed against the web of cellulose substrate, coating one or both sides of the band. The coating layers may be added simultaneously or in stages according to one of two techniques typically used in industry. The thickness, weight, rigidity and resistance to curling are mostly identical with either of two techniques.

The size press treatment used is preferably an application with a metering size press. Due to the nature of the size press with metering unit, the application of the solids can be controlled and standardized. Consequently, the penetration of the coating of super-hydrophobic composition in the cellulose substrate is minimal, while maintaining the effect of the single sheet structure of three layers. Still, size presses known in the art may be used, such as a flood coater application between rolls. In this case, the potential application of the starch solutions to the outer layers is not the same as for gluing units with dosing due to intrinsic deeper penetration into the sheet in the flood coater between rollers.

Subsequently, the coated web with the cellulose substrate coated with the super-hydrophobic composition is transported for treatment by the size press at the dry end of the papermaking machine, where the dry end typically comprises a multiplicity of rotary cylinders heated with steam under a hood structure with heat confined close to the route followed by the paper web for further drying the paper after the application of the size press.

In another embodiment of the invention, a cellulose substrate, previously prepared under continuous process of making paper from the prior art, is placed on a roller that feeds a coating machine that will apply a super-hydrophobic composition of the invention in one or both sides of the cellulose substrate to the moment when this is unwound.

The resulting paper substrate in both alternatives described above exhibits one or more enhanced properties compared to substrates which do not include the super-hydrophobic composition of the invention. For example, for some embodiments of the present invention, the cellulose substrate exhibits an improved ability for release or anti-adhesion (capacity to release paper from foods or molds) and a super water and honey repellency, i.e. displacing water and honey fast and perfectly under the TAPPI test to water repellency with the RC-212 method.

### EXAMPLES OF EMBODIMENTS OF THE INVENTION

The invention will now be described with respect to the following examples which are solely for the purpose of representing the way to carry out the implementation of the principles of the invention. The following examples are not intended as a comprehensive representation of the invention, nor intended to limit the scope thereof.

In this application all units are in the metric system and all amounts and percentages are by weight unless otherwise indicated.

### Example 1

A super-hydrophobic composition with 16 kg of Quilon®, 16 kg of Aerosil® R972 and 948 liters of water.

### Example 2

A super-hydrophobic composition with 16 kg of Quilon®, 16 kg of Aerosil® R972, 10 kg of soy lecithin, 50 kg of calcium stearate, and 888 liters of water.

### Example 3

A super-hydrophobic composition with 16 kg of Quilon®, 16 kg of Aerosil® R972, 300 liters of ethyl alcohol, 15 kg of latex, 10 kg of Celvol® 350, and 623 liters of water.

### Example 4

A super-hydrophobic composition with 16 kg of Quilon®, 16 kg of Aerosil® R972, 200 liters of isopropyl alcohol, 15 kg of latex, 10 kg of Celvol® 350, and 723 liters of water.

### Example 5

A super-hydrophobic composition with 16 kg of Quilon®, 16 kg of Aerosil® R972, 300 liters of ethyl alcohol, 15 liters of stearyl alcohol, 15 kg of latex, 10 kg of Celvol® 350, and 608 liters of water.

### Example 6

A super-hydrophobic composition with 16 kg of Quilon®, 16 kg of Aerosil® R972, 300 liters of ethyl alcohol, 15 kg of latex, 10 kg of Celvol® 350, 10 kg of chitosan, 10 kg of acetylated starch, and 603 liters of water.

### Example 7

A super-hydrophobic composition with 16 kg of Quilon®, 16 kg of Aerosil® R972, 10 kg of soy lecithin, 10 kg of latex, 10 kg of Celvol® 350, 10 kg of acetylated starch, 10 liters of stearyl alcohol, and 898 liters of water.

### Example 8

A super-hydrophobic composition with 16 kg of Quilon®, 16 kg of Aerosil® R972, 10 kg of soy lecithin, 10 kg of latex, 10 kg of Celvol® 350, 10 kg of ethylated starch, and 908 liters of water.

### Example 9

A super-hydrophobic composition with 16 kg of Quilon®, 16 kg of Aerosil® R972, 50 kg of calcium stearate, 10 kg of latex, 10 kg of Celvol® 350, 10 kg of acetylated starch, and 868 liters of water.

### Example 10

A super-hydrophobic composition with 16 kg of Quilon®, 16 kg of Aerosil® R972, 50 kg of calcium stearate, 10 kg of latex, 10 kg of Celvol® 350, 10 kg of athylated starch, and 868 liters of water.

### Example 11

A super-hydrophobic composition with 16 kg of Quilon®, 16 kg of Aerosil® R972, 50 kg of calcium stearate, 300 liters of ethylated alcohol, 15 kg of latex, 10 kg of Celvol® 350, 20 kg of chitosan, and 553 liters of water.

### Example 12

A super-hydrophobic composition with 16 kg of Quilon®, 16 kg of Aerosil® R972, 50 kg of calcium stearate, 300 liters of isopropylic alcohol, 15 kg of latex, 10 kg of Celvol® 350, 20 kg of chitosan, and 553 liters of water.

Each of the compositions described in Examples 1 to 12 were applied on both sides in 3 sample sheets of cellulose substrate (paper) which were subjected to physical testing to determine, by visual assessment, olfactory and touch, their heat resistance, non-sticking properties and water or honey repellency.

The test of water or honey repellency consisted in placing the sample sheets in accordance to what is described in the TAPPI test for water repellency with method RC-212. Next a dripping of water or honey was applied to them, observing their respective displacement.

The tests consisted in placing in the center of the sample sheet 1 a crude biscuit, in the center of the sample sheet 2 a biscuit with excess water, and in the center of the sample sheet 3 a biscuit with excess sugar or honey. Each of the three samples for each of the examples 1 to 12 were placed on a plastic tray and introduced separately in a furnace by combination of hot air, microwave and infrared heating of the TurboChef® brand, model Tornado® manufactured by TurboChef Technologies, Inc. at a firing temperature of about 260° C. to 345° C. for 20 seconds and was previously switched on for three hours. Later each sample was removed from the furnace and then the biscuit was removed to evaluate the degree of heat resistance and release properties of each of the samples for each of the examples. Also, sample sheets 1, 2 and 3, for each of the Examples 1 to 12, were reused several times for which on every sheet in its center a crude biscuit, a biscuit with excess water, and a biscuit with an excess of sugar or honey was placed, respectively, this in order to test the capability of retaining or maintaining the heat resistance properties, release properties and water or honey repellency, even when the paper is reused.

The results obtained from the former tests are shown in Tables 4 and 5, indicating the value of the degree of water or honey repellency, based on the scale of “A” to “H” of the TAPPI test for water repellency with the method RC-212, where “A” is a perfect shift, “B” few round drops on the way, “C” round drops cover ¼ of the way, oval drops cover ¼ of the way, “E” ½ of the way is wet, “F” irregular moist narrower than a drop, “G” continuous moist, slightly narrower than the drop, and “H” continuous moist as wide as the drop. Also the contact angle of water or honey and the values of the degree of heat resistance and anti-sticking properties with respect to a scale of 0 to 5 are shown, wherein:

To test for anti-adhesion:
0 means very poor, i.e. fat passes the paper completely and biscuit remains bonded thereto.
1 means bad, that is, fat passes the paper and ¾ of the biscuit approximately sticks to the paper that it was in contact with.
2 means regular, that is, fat passes slightly through the paper and 2/4 of the biscuit approximately sticks to the paper that it was in contact with.
3 means good, that is, there is a slight grease spot on the paper and traces of the biscuit adhered to the paper.
4 means very good, that is, there is a very slight grease spot on the paper and no traces of the biscuit adhered to the paper.
5 means excellent, that is, there is no grease spot on the paper and there are no traces of the biscuit adhered to the paper.

To test for heat resistance:
0 is very bad, that is, all the paper sample shows a dark brown color, compared with a sample of paper not being tested.
1 means bad, that is, the surface of the paper sample is observed approximately 80% dark brown and the remaining part is light brown, compared with a sample of paper not being tested.
2 means regular, that is, the surface of the paper sample is observed approximately 50% dark brown and the remaining part is light brown, compared with a sample of paper not being tested.
3 means good, that is, the surface of the paper sample is observed approximately 30% light brown and the remaining part is yellowish brown, compared with a sample of paper not being tested.
4 means very good, that is, the surface of the paper sample is observed approximately 20% yellowish and the remaining part is very light yellow, compared with a sample of paper not being tested.
5 is excellent, that is, the sample paper shows no degradation of color, compared with a sample of paper not being tested.

TABLE 4

| | Example | Example | Example | Example | Example | Example |
|---|---|---|---|---|---|---|
| | 1 | 2 | 3 | 4 | 5 | 6 |
| Tests on paper | | | | | | |
| Water repellency | A | A | A | A | A | A |
| (TAPPI method | | | | | | |
| RC212) | | | | | | |
| Repellency to honey | A | A | A | A | A | A |
| (TAPPI method | | | | | | |
| RC212) | | | | | | |
| Water contact angle | 115-120 | 115-160 | 115-150 | 115-150 | 115-150 | 115-150 |
| (°) | | | | | | |
| Paper in furnace with | | | | | | |
| raw biscuit | | | | | | |
| Anti-adhesion | 5 | 5 | 5 | 5 | 5 | 5 |
| Heat Resistance | 5 | 5 | 5 | 5 | 5 | 4 |
| Paper in furnace with | | | | | | |
| biscuit with excess | | | | | | |
| water | | | | | | |
| Anti-adhesion | 5 | 5 | 5 | 4 | 4 | 4 |
| Heat Resistance | 5 | 5 | 5 | 4 | 4 | 4 |
| Paper in furnace with | | | | | | |
| biscuit with excess | | | | | | |
| sugar or honey | | | | | | |
| Anti-adhesion | 5 | 5 | 5 | 4 | 4 | 4 |
| Heat Resistance | 5 | 5 | 5 | 3 | 3 | 3 |
| Paper re-used in | | | | | | |
| furnace with raw | | | | | | |
| biscuit | | | | | | |
| Number of times the | 4 | 5 | 3 | 4 | 3 | 3 |
| paper was re-used | | | | | | |
| Anti-adhesion | 5 | 5 | 5 | 5 | 4 | 5 |
| Heat Resistance | 5 | 4 | 4 | 4 | 4 | 3 |
| Re-used paper | | | | | | |
| baking biscuit with | | | | | | |
| excess water | | | | | | |
| Number of times the | 4 | 5 | 3 | 4 | 3 | 4 |
| paper was re-used | | | | | | |
| Anti-adhesion | 5 | 5 | 3 | 4 | 3 | 4 |
| Heat Resistance | 5 | 4 | 3 | 3 | 3 | 3 |
| Paper in furnace re- | | | | | | |
| used with biscuit | | | | | | |
| with excess sugar | | | | | | |
| Number of times the | 4 | 4 | 3 | 3 | 2 | 3 |
| paper was re-used | | | | | | |
| Anti-adhesion | 5 | 5 | 4 | 4 | 5 | 4 |
| Heat Resistance | 5 | 4 | 3 | 3 | 3 | 3 |

TABLE 5

| | Example | Example | Example | Example | Example | Example |
|---|---|---|---|---|---|---|
| | 7 | 8 | 9 | 10 | 11 | 12 |
| Tests on paper | | | | | | |
| Water repellency | A | A | A | A | A | A |
| (TAPPI method | | | | | | |
| RC212) | | | | | | |
| Repellency to honey | A | A | A | A | A | A |
| (TAPPI method | | | | | | |
| RC212) | | | | | | |
| Water contact angle | 115-150 | 115-150 | 115-150 | 115-150 | 115-150 | 115-150 |
| (°) | | | | | | |
| Paper in furnace with | | | | | | |
| raw biscuit | | | | | | |
| Anti-adhesion | 5 | 5 | 5 | 5 | 5 | 5 |
| Heat Resistance | 4 | 4 | 4 | 4 | 4 | 4 |
| Paper in furnace with | | | | | | |
| biscuit with excess | | | | | | |
| water | | | | | | |
| Anti-adhesion | 3 | 3 | 3 | 4 | 4 | 4 |
| Heat Resistance | 4 | 4 | 5 | 5 | 4 | 5 |
| Paper in furnace with | | | | | | |
| biscuit with excess | | | | | | |
| sugar or honey | | | | | | |
| Anti-adhesion | 5 | 4 | 4 | 3 | 4 | 4 |
| Heat Resistance | 4 | 4 | 4 | 4 | 3 | 4 |
| Paper re-used in | | | | | | |
| furnace with raw | | | | | | |
| biscuit | | | | | | |
| Number of times the | 3 | 3 | 3 | 4 | 4 | 3 |
| paper was re-used | | | | | | |
| Anti-adhesion | 4 | 5 | 5 | 4 | 4 | 4 |
| Heat Resistance | 3 | 3 | 4 | 4 | 4 | 4 |
| Paper in furnace re- | | | | | | |
| used with biscuit | | | | | | |
| with excess water | | | | | | |
| Number of times the | 3 | 3 | 3 | 4 | 4 | 3 |
| paper was re-used | | | | | | |
| Anti-adhesion | 3 | 3 | 3 | 4 | 4 | 3 |
| Heat Resistance | 3 | 3 | 4 | 4 | 4 | 4 |
| Paper in furnace re- | | | | | | |
| used with biscuit | | | | | | |
| with excess sugar | | | | | | |
| Number of times the | 3 | 2 | 2 | 3 | 3 | 2 |
| paper was re-used | | | | | | |
| Anti-adhesion | 5 | 4 | 4 | 4 | 4 | 4 |
| Heat Resistance | 3 | 3 | 4 | 4 | 4 | 4 |

Although the invention has been described with respect to a preferred embodiment, those skilled in the art will understand that various changes may be made and equivalents may be substituted by its elements without separating from the scope of the invention. In addition, many modifications may be made to adapt a particular situation or material to the contents of the invention, without separating from the essential scope thereof. Therefore, the invention is not intended to be limited to the particular embodiment disclosed as the best mode contemplated for carrying out this invention, but that the invention will include all embodiments falling within the scope of the appended claims.

1. A super-hydrophobic composition for coating of substrates comprising:
at least one hydrophobic agent of chromium complex; and
inorganic nanoparticles chosen from a group consisting of hydrophobic nanoparticles, hydrophilic nanoparticles and combinations thereof, with an average particle size of 1 nm to 35 nm.

2. The composition of claim 1, comprising:
from 0.01% by weight to 50% by weight of hydrophobic agent of chromium complex; and
of 0.01% by weight to 50% by weight of inorganic nanoparticles.

3. The composition of claim 2, wherein comprises from 3% to 30% by weight of hydrophobic agent of chromium complex.

4. The composition of claim 2, wherein comprises from 5% to 35% by weight inorganic particles.

5. The composition of claim 1, wherein has a water contact angle from 115° to 160°.

6. The composition of claim 1, wherein said inorganic nanoparticles is selected from a group consisting of alumina nanoparticles, silica nanoparticles, titanium oxide nanoparticles, zirconium oxide nanoparticles, gold nanoparticles, silver nanoparticles, nickel nanoparticles, nickel oxide nanoparticles, iron oxide nanoparticles, nanoparticles of alloys, and combinations thereof.

7. The composition of claim 1, wherein said nanoparticles have a particle size of 5 nm to 20 nm.

8. The composition of claim 1, wherein further includes at least one metal salt lubricant selected from a group consisting of calcium stearate, sodium stearate, potassium stearate, ammonium stearate.

9. The composition of claim 10, wherein comprises from 0.01% to 10% by weight of calcium stearate.

10. The composition of claim 9, wherein comprises from 1% to 5% by weight of calcium stearate.

11. The composition of claim 1, wherein comprises at least one lecithin.

12. The composition of claim 10, wherein comprises from 0.01% to 10% by weight of said lecithin.

13. The composition of 11, wherein comprises from 0.3% to 2% by weight of said lecithin.

14. The composition of claim 11, wherein said lecithin is soy lecithin.

15. A process for preparing a composition for super-hydrophobic coating substrates in accordance with what is claimed in any of claims 1 to 14, using the resulting mixture, which comprises mixing at least one hydrophobic agent of chromium complex and inorganic nanoparticles selected from a group consisting of hydrophobic nanoparticles, hydrophilic nanoparticles and combinations thereof, with an average particle size of 1 nm to 35 nm.

16. Use of a super-hydrophobic composition according to any of claims 1 to 14 or of the super-hydrophobic composition prepared by the process claimed in claim 15 for producing a super-hydrophobic paper.
